(19) United States
(12) Patent Application Publication
(10) Pub. No.: US 2013/0048575 A1
(43) Pub. Date: Feb. 28, 2013

(54) SYSTEMS AND METHODS FOR MOBILE FRACKING WATER TREATMENT

(71) Applicants: Eli Gruber, Roswell, GA (US); Miguel Ribeiro, Duluth, GA (US)

(72) Inventors: Eli Gruber, Roswell, GA (US); Miguel Ribeiro, Duluth, GA (US)

(73) Assignee: ECOLOGIX ENVIRONMENTAL SYSTEMS, LLC, Alpharetta, GA (US)

(21) Appl. No.: 13/591,638

(22) Filed: Aug. 22, 2012

Related U.S. Application Data
(60) Provisional application No. 61/526,106, filed on Aug. 22, 2011.

(51) Int. Cl. C02F 1/24; B01D 21/24; B01D 21/18; B01D 21/04; B01D 21/08

(52) U.S. Cl. 210/749; 210/241; 210/221.2; 210/194; 210/85; 210/205; 210/207

(57) ABSTRACT

The present disclosure relates to water treatment systems, and specifically to mobile flotation tanks, mobile chemical mix tanks, and mobile integrated water treatment systems, and methods regarding the same.

### CROSS-REFERENCE TO RELATED APPLICATIONS

This application claims the benefit of U.S. Provisional Application No. 61/526,106, filed on Aug. 22, 2011, which is incorporated herein by reference in its entirety.

### TECHNICAL FIELD

The present disclosure relates to mobile integrated water treatment systems, and specifically to mobile chemical mix tanks and mobile flotation tanks, including methods regarding the same.

### BACKGROUND

In recent years, the technology to access and extract oil and natural gas from shale deposits has developed. Several studies have estimated that the amount of oil and natural gas contained in shale deposits, such as the Marcellus Shale formation in New York, Pennsylvania, and West Virginia, could provide the equivalent of one hundred years of energy for the United States. The Marcellus Shale formation alone is estimated to contain at least 168 trillion cubic feet of natural gas, and potentially as much as 516 trillion cubic feet of natural gas.

While the fracturing technology used to extract natural gas from these shale formations can be effective, there are a number of environmental concerns associated with the technology. In particular, a significant amount of water is required for each hydraulic fracturing operation, and, once used, that water must be treated prior to discharge into natural or municipal water systems. Due to the chemical additives added to the process water and the contaminants picked up during use, the post-frac water cannot be treated using traditional municipal treatment systems.

In a traditional fracturing operation, fresh water is transported to the well site via large trucks. Large impound ponds are created adjacent to the well site to hold used process water. This contaminated or raw water is then transported via trucks to a centralized or regional treatment center.

The existing technologies for treating used process or raw water have significant disadvantages. Evaporation techniques concentrate suspended and dissolved solids but still result in substantial waste-water volume. Spray pit approaches produce aerosol emissions that can contain dangerous or corrosive chemicals but are otherwise ineffective. Injection wells wherein used process water is pumped into other subterranean formations can result in contamination of natural aquifers. Ion exchange technologies can remove ions such as calcium, magnesium, and salts, such as sodium chloride, but are slow and expensive and do not remove other contaminants. Similarly, reverse osmosis technologies do not address hydrocarbons that can be present. Storage vessels, such as frac tanks, can be used to store flow-back water and allow suspended solids to settle, for example, after chemical or electrical coagulation, but the suspended solids are typically mixed or emulsified with hydrocarbons that prevent or delay settling. Settling techniques are therefore generally ineffective for frac flow-back water.

### SUMMARY

The present disclosure relates to mobile water treatment systems and, specifically, to mobile chemical mix tanks and mobile flotation tanks, referred together as mobile integrated water treatment systems, including methods regarding the same.

Provided in the presented disclosure is a mobile flotation cell system. The mobile flotation cell system includes a flotation tank comprising an angled bottom portion. The flotation tank further includes at least one influent chamber, at least one separation tank, and at least one sludge chamber. The mobile flotation cell system further includes a trailer, one or more injection pumps, and a scraper assembly. The system also includes influent and effluent piping assemblies. The flotation tank, one or more injection pumps, one or more sludge pumps, scraper assembly, and influent and effluent piping assemblies are adapted to be positionable on the trailer.

Also provided is a mobile chemical treatment cell system, which includes a chemical mix tank with two or more cascading, tiered platforms. The chemical treatment cell also includes one or more chemical injection ports, one or more mixers, and influent and effluent piping assemblies. The system further includes a trailer, and the chemical mix tank and all components of chemical treatment cell system may be positioned on the trailer.

Also provided in the present disclosure is an integrated treatment system. The integrated treatment system includes a chemical mix tank with two or more cascading, tiered platforms. The chemical mix tank further includes one or more mixers, one or more chemical injection ports, and influent and effluent piping assemblies. The chemical mix tank and all of the components thereof are positionable on a trailer. The integrated treatment system further includes a flotation tank with an angled bottom portion and a scraper assembly. The flotation tank also provides for one or more injection pumps, one or more sludge pumps, and at least one influent chamber. Furthermore, the flotation tank includes at least one sludge chamber and influent and effluent piping assemblies. The flotation tank and all of the components thereof are positionable on a trailer.

Also provided in the current disclosure is a method for treating raw water. The method includes providing a chemical mix tank, and the chemical mix tank includes one or more mixers and one or more chemical injection ports, or a combination thereof. A flotation tank is also provided, and the flotation tank includes an angle-shaped bottom portion and a scraper assembly. Raw water is introduced into the chemical mix tank, and treatment chemicals are then introduced into the chemical mix tank.

Once the raw water has been treated with the treatment chemicals, the chemically-treated water is transported from the chemical mix tank to the flotation tank. In the flotation tank, a gas is injected, dissolved, and/or entrained into the chemically-treated raw water within the flotation tank. The sludge is removed from the chemically-treated water in the flotation tank to produce treated water. The method may be used in the oil and gas industry, and may optionally be used in the offshore setting. The method may be used where mobile or immobile treatment of raw is appropriate.

These and other features and advantages of the implementations of the present disclosure will become more readily apparent to those skilled in the art upon consideration of the following detailed description and accompanying drawings, which describe both the preferred and alternative implementations of the present disclosure.

### BRIEF DESCRIPTION OF THE DRAWINGS

In the drawings, like reference numbers and designations in the various drawings indicate like elements.

FIGS. 1A-1C are schematic illustrations showing isometric views of example mobile flotation cell systems;

FIG. 1D is a schematic illustration showing an isometric view of an example mobile flotation cell system during transportation;

FIG. 1E is a schematic illustration showing a side view of an example mobile flotation cell system during transportation;

FIGS. 1F-1G are schematic illustrations showing top views of example mobile flotation cell systems;

FIG. 1H is a schematic illustration showing the proximate view of an example mobile flotation cell system;

FIGS. 2A-2B are schematic illustrations showing isometric views of example mobile chemical treatment cell systems;

FIGS. 3A-3B are schematic illustrations showing isometric views of example mobile integrated treatment systems;

FIGS. 4A-4C are schematic illustrations showing isometric views of example mobile integrated treatment systems; and

FIG. 4D is a schematic illustration showing an isometric view of an example mobile integrated treatment system during transportation.

### DETAILED DESCRIPTION

Implementations of the present disclosure now will be described more fully hereinafter. Indeed, these implementations can be embodied in many different forms and should not be construed as limited to the implementations set forth herein; rather, these implementations are provided so that this disclosure will satisfy applicable legal requirements. As used in the specification, and in the appended claims, the singular forms “a,” “an,” and “the,” include plural referents unless the context clearly indicates otherwise. The term “comprising” and variations thereof as used herein is used synonymously with the term “including” and variations thereof and are open, non-limiting terms.

As used herein, and unless specifically stated to the contrary, the terms frac, fracing, fracturing, and/or hydrofracing are all intended to refer to the hydraulic fracturing process, such as, for example, can be used to extract natural gas from a shale formation. As used herein, the terms raw water, process water, contaminated water, or flow-back water are all intended to refer to the water or fluid produced as a result of the hydraulic fracturing process.

As briefly described above, the present disclosure provides an integrated water treatment system. In one aspect, the integrated treatment is capable of treating process water recovered during a fracturing operation, for example, to extract natural gas from a shale deposit. The water treatment system and methods may also be used in other appropriate industries outside of the oil and gas industry. In other aspects, a water treatment system and methods for treating process water using the inventive system are disclosed herein.

The fact that naturally occurring shale formations in the United States contain oil and natural gas has been known for some time, but efficient technologies for recovering these energy sources have only recently been developed. Hydraulic fracturing is a process of creating and propagating fractures in subterranean rock layers by injecting a fluid into a wellbore and then pressurizing that fluid. The fluid typically contains proppants, or particles that can remain in the formation. When the pressure on the fluid in the wellbore is released, a large portion of the fluid is expelled from the wellbore, leaving proppant particles in the formation. The presence of these proppant particles helps to keep fractures open, thus allowing gas contained in the formation to escape.

Hydraulic fracturing techniques can be used to increase or restore the rate at which fluids, such as natural gas, can be produced from subterranean natural reservoirs, including unconventional reservoirs such as shale formations. Hydraulic fracturing can thus enable the production of natural gas from rock formations deep below the earth's surface, where otherwise the lack of porosity or permeability would prevent recovery of the natural gas.

In a conventional fracing operation, a fracturing fluid is pumped into a wellbore at a rate sufficient to increase the downhole pressure to a value in excess of the fracture gradient of the formation rock. The pressure causes the formation to crack, allowing the fracturing fluid to enter and extend the crack farther into the formation. To keep this fracture open after the injection stops, a solid proppant, such as sand, can be added to the fracture fluid. The propped hydraulic fracture then becomes a high permeability conduit through which the formation fluids can flow to the well.

The fracture fluid injected into the rock can typically comprise water and optionally gels, foams, compressed gases, or combinations thereof. Thus, although water is used throughout as an exemplary fluid, various fluids could be used as a fracture fluid. Conventional proppant materials can include silica sand, resin-coated sand, ceramics, or combinations thereof.

Various chemical additives can also be added to the fracture fluid or separately injected into the wellbore, for example, to protect the well or improve its operation. As environmental, flow, and/or well conditions change, the composition of the injected fluids can also be changed.

When the pressure on the fracture fluid is released, the raw water produced is typically placed in storage pits, ponds, or containers. The presence of chemical additives, suspended and dissolved solids, and radioactivity render the fluid unsuitable for discharge into natural or municipal water systems without extensive treatment.

One of the challenges in fracturing operations is the management of fresh and used raw water. Concerns are growing with regard to metals and other chemicals that can be present in used raw water. In conventional operations, the used water is either pumped to holding ponds or stored in tanks before being transported to a centralized regional treatment center. If left in a holding pond, these metals and other chemicals can potentially leach into the ground and surrounding water table. When transported, spills can occur, dumping toxins onto roadways and aquifers.

In addition to contaminants picked up from contact with subterranean formations, a number of chemicals can be added to fracture fluids, including, for example, acids for facilitating entry into rock formations, biocides (e.g., glutaraldehyde, 2,2-dibromo-3-nitrilopropionamide) to prevent fouling, breaker agents (e.g., peroxodisulfates) and crosslinking agents (e.g., potassium hydroxide) to assist with proppant delivery, clay stabilizers (e.g., tetramethylammonium chloride and other salts), corrosion inhibitors (e.g., methanol), friction modifiers (e.g., sodium acrylate, polyacrylamide), gelling agents (e.g., guar gum), iron control (e.g., citric acid, thioglycolic acid) and scale inhibitor (e.g., ammonium chloride, ethylene glycol, polyaccrylate) agents, surfactants (e.g., methanol, isopropanol), or combinations thereof. These chemical additives can be present in the water recovered from the formation and should be taken into consideration during treatment.

Conventional fracturing processes inject very large volumes of water, for example, up to several million gallons, under high pressure into the rock formations to produce a network of cracks and fissures that will enable natural gas to escape. As described above, the raw water recovered from the wellbore needs to be treated before being discharged or reused.

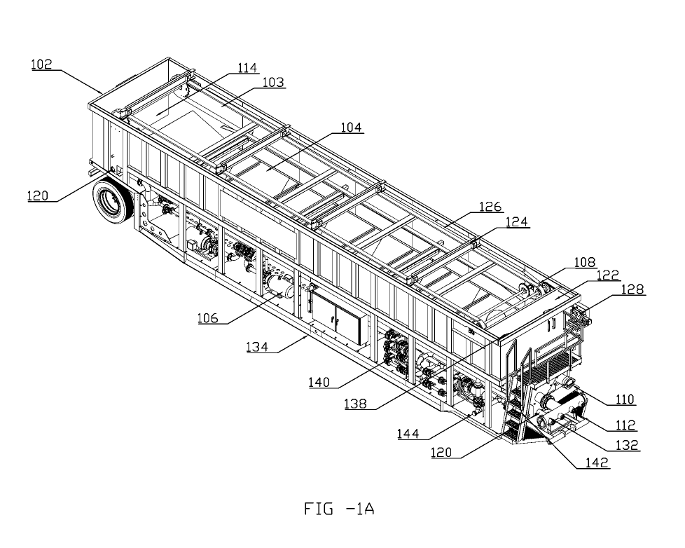

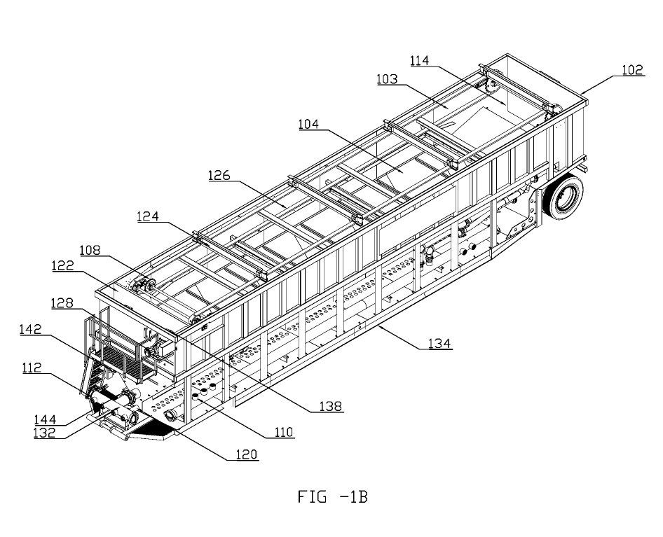

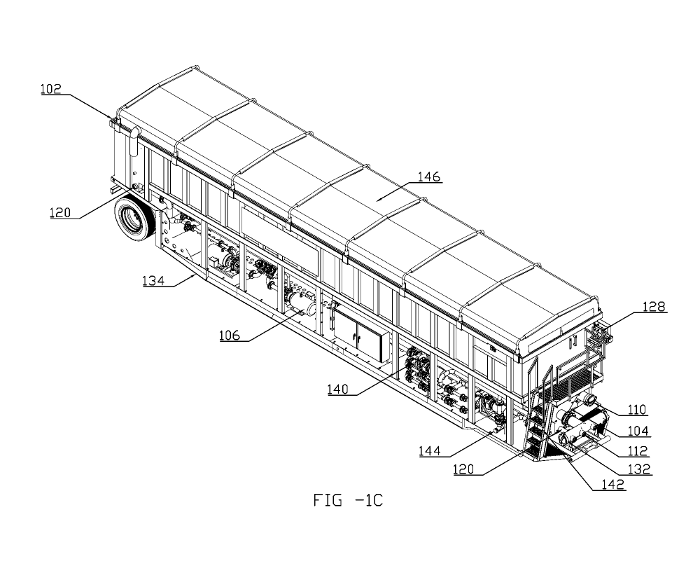

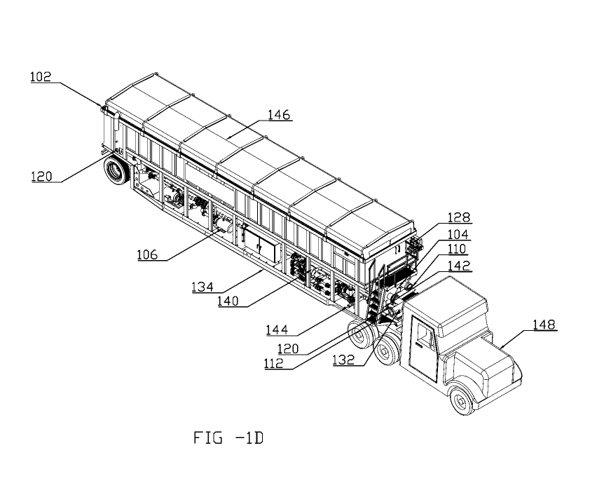

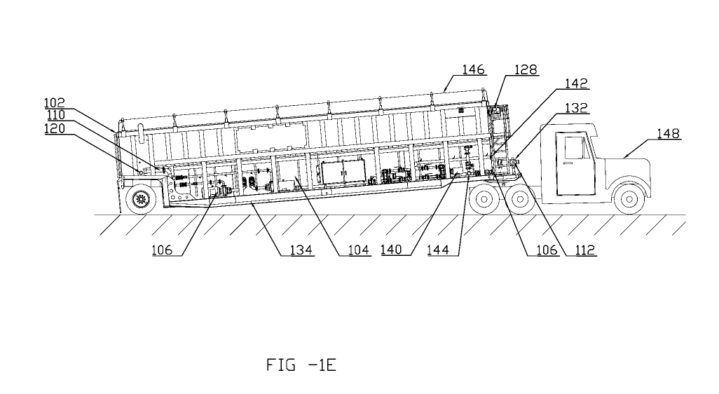

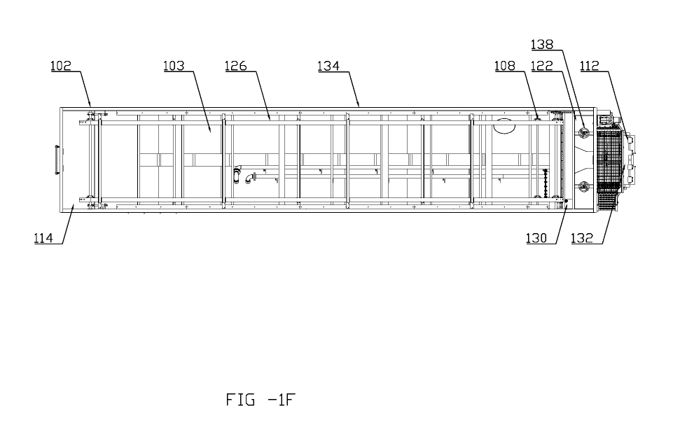

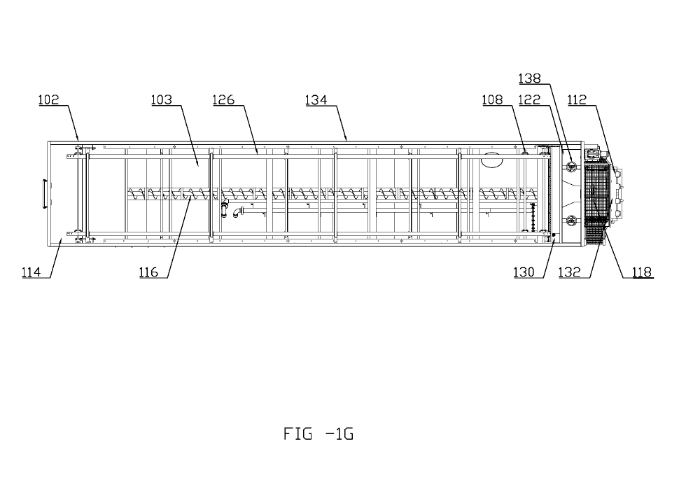

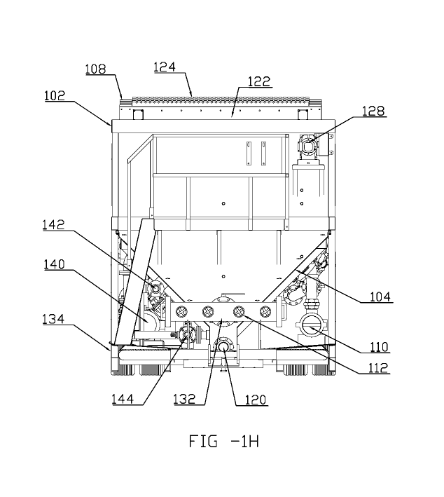

The present disclosure relates to water treatment systems, and specifically to mobile chemical mix tanks, mobile flotation tanks, and mobile integrated water treatment systems, including methods regarding the same. The present disclosure includes a mobile flotation cell system. Referring to FIGS. 1A-1H, example mobile flotation cell systems are shown. The example mobile flotation cell system includes a flotation tank 102 comprising an angled bottom portion 104. The flotation tank 102 further includes at least one influent chamber 114, at least one separation tank 103, and at least one sludge chamber 130. The example mobile flotation cell system further includes a trailer 134, one or more injection pumps 106, and a scraper assembly 108. The system also includes influent 110 and effluent 112 piping assemblies and one or more sludge pumps 140. The flotation tank 102, one or more injection pumps 106, one or more sludge pumps 140, scraper assembly 108, and influent 110 and effluent 112 piping assemblies are adapted to be positionable on the trailer 134.

The influent piping assembly 110 of the mobile flotation cell system optionally accepts raw water. The example mobile flotation cell system may also include at least one influent chamber 114 connectably attached to the influent piping assembly 110. For example, raw water accepted through the influent piping assembly 110 may be transported to the influent chamber 114. The raw water may optionally include chemically-treated water, which is water that is treated with one or more treatment chemicals before transportation into the influent chamber 114.

The angled bottom portion 104 of the flotation tank 102 may be configured such that solid waste settles in the bottom of the angled bottom portion 104. The angled bottom portion optionally includes a V-shaped bottom portion. The mobile flotation cell system may also include a sludge auger 116 positioned at the base of the angled bottom portion 104 of the flotation tank 102, as shown in FIG. 1G. The sludge auger 116 optionally includes an auger motor 118 to advance and/or cause rotation of the sludge auger 116.

The mobile flotation cell system may also include an effluent sludge waste drain 120. The sludge auger 116 optionally moves the sludge waste to the effluent sludge drain 120 and from there it may be pumped into a sludge storage unit (not shown), which may include a dewatering treatment system or an external sludge storage tank. The advancement and/or rotation of the sludge auger 116 optionally moves the sludge waste into a sludge chamber 130. The sludge waste may be stored in the sludge chamber 130 until removal, dewatering, and/or disposal.

One or more injection pumps 106 are included for optionally injecting, dissolving, and/or entraining a gas into the raw water within the influent chamber 114. The gas may include air, methane, or a combination thereof. The injecting, dissolving, and/or entraining a gas into the raw water within the influent chamber 114 may cause particulate matter suspended in the water to float to the surface. The raw water and suspended particulate matter may move or may be transported from the at least one influent tank 114 to the separation tank 103.

The scraper assembly 108 optionally includes one or more mechanical blades 124. The mechanical blades 124 may span the width of the flotation tank 102. Furthermore, the one or more mechanical blades 124 may attach to a chain, rope, and/or cable 126. The mobile flotation cell system may also include a scraper assembly motor 128. For example, the scraper assembly motor 128 may advance the rope, chain, and/or cable 126 that the one or more mechanical blades 124 are attached thereto along the length of the separation tank 103.

The one or more mechanical blades 124 optionally skim or remove the floating contaminants from the surface of the raw water in the separation tank 103. The flotation tank 102 may also include at least one sludge chamber 130 at the proximal end of the flotation tank 102. The one or more mechanical blades 124 may skim or remove the floating contaminants from the surface of the raw water, and the floating contaminants may be placed in the sludge chamber 130. The one or more mechanical blades 124 may skim the surface of the raw water in a direction that is in a co-current or countercurrent flow of the raw water.

All or a portion of the water contained within the floating contaminants may be removed to form a resulting sludge. For example, the removal of all or a portion of the water may be performed with a filter press. The water removed from the floating contaminants may be returned to the flotation tank 102. A sludge discharge connection 142 may also be provided, and the sludge discharge connection 142 may optionally be connected to the sludge chamber 130 and one or more sludge pumps 140. The resulting sludge may optionally be pumped through the sludge discharge connection 142 by the one or more sludge pumps 140. The resulting sludge may be dried and disposed thereof. A sediment tank (not shown) may also be provided, and sludge discharge connection 142 may be attached to the sediment tank. The resulting sludge may be pumped by the one or more sludge pumps 140 through the sludge discharge connection 142 and into the sediment tank for storage.

In removing the resulting sludge and the sludge waste from the raw water in the flotation tank, treated water may be produced. The treated water may be transported to a clearwell 122. The treated water in the clearwell 122 may also be returned to the flotation tank 102. A portion of the treated water may be returned to the influent chamber 114. A portion of the treated water may optionally be returned to the one or more injection pumps 106 for injecting, dissolving, and/or entraining a gas into the raw water in the influent chamber 114. The portion of the treated water returned to the one or more injection pumps 106 may be about 30%. The various pumps are optionally situated on the trailer 134 adjacent to the angled bottom portion 104 of the flotation tank 102. Furthermore, the system may be used in the oil and gas industry.

Optionally, the treated water may be transported through the effluent piping assembly 112 to a holding tank (not shown), other storage means (not shown), and/or the field for further use. The effluent piping assembly 112 may include a header 132 that measures about 8 inches.

The example mobile flotation cell system may also include a flow mechanism (not shown). For example, the flow mechanism may cause the raw water to flow in a first direction through the flotation tank. One or more gases may be injected by one or more flow mechanisms at one or more points in an opposing and/or orthogonal direction to the first direction of the raw water, such that turbulent conditions are maintained.

The mobile flotation cell system may be transported and positioned adjacent or proximate to a raw water source. The convenience of co-locating the mobile flotation cell system at the fracturing well site may significantly reduce cost and environmental concerns. In one aspect, all or a portion of the treated water may be reused, reducing and/or eliminating the need to bring in large quantities of fresh water or remove large quantities of raw water. In another aspect, flow back water treated onsite may be discharged into the environment or surrounding area without adversely affecting local aquifers.

The entire system and all components of the mobile flotation cell system may be adapted for clearance below the uppermost part of the flotation tank 102 for transportation of the entire system. The trailer 134 may optionally include a standard frac tank chassis. For example, the trailer 134 may include a standard 452-inch floor assembly. The trailer 134 may include a standard 488-inch or 500-inch floor assembly, or a trailer or floor assembly of any other appropriate length. The trailer optionally includes a longitudinally sloped chasis, such that any water or liquid may flow via gravity from the distal end of the trailier to the proximal end. The degree of longitudinal slope may be about 5 degrees. The trailer may also include an ISO-20 or ISO-40 container. The trailer optionally includes a single axle trailer or a flatbed. The mobile flotation cell system may optionally include a cover 146.

In transporting the entire system by a tractor trailer truck 148 or other appropriate hauling equipment, for example, the system may be adapted for clearance below all bridges and other structures during transportation. The entire system and all components, including controls, piping, valves, pumps, instrumentation, mixers, and chemical injection modules, may be prefabricated and transported. In such an aspect, the only connections that need to be made onsite are for electrical power and the raw water. In other aspects, a generator (not shown) may also be provided, so that the system is self-sustaining and does not require external support.

The mobile flotation cell system may include monitoring equipment (not shown), and the monitoring equipment optionally monitors various water conditions. For example, the monitoring equipment may monitor various water conditions, such as pH, turbidity, and/or mineral content. During the monitoring of various water conditions, pH control additives or other chemical additives may be added in response to various water conditions, thus maintaining efficient treatment. The monitoring equipment, all controls, and all pumps may optionally be positioned on one side of the mobile flotation tank cell. Furthermore, all connections may be placed on the front of the trailer 134 or on the side of the mobile flotation tank cell opposite of the one including the monitoring equipment, all controls, and all pumps. Therefore, an operator may quickly evaluate the pumps, monitoring equipment, and all controls from one side of the trailer 134.

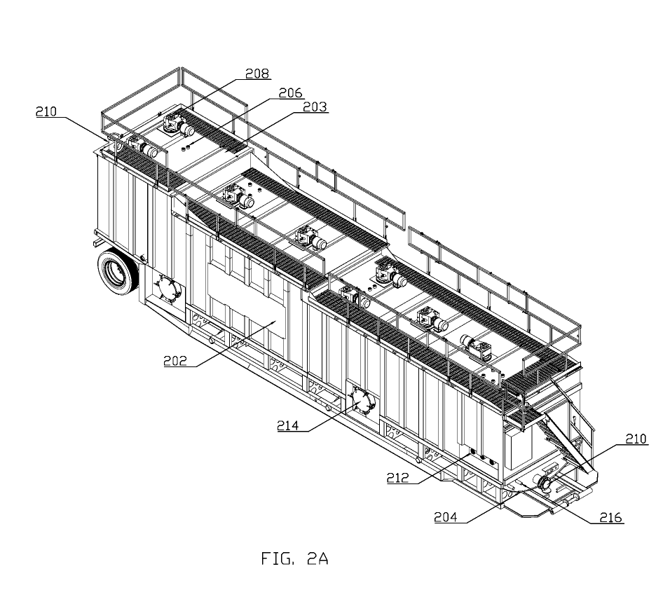

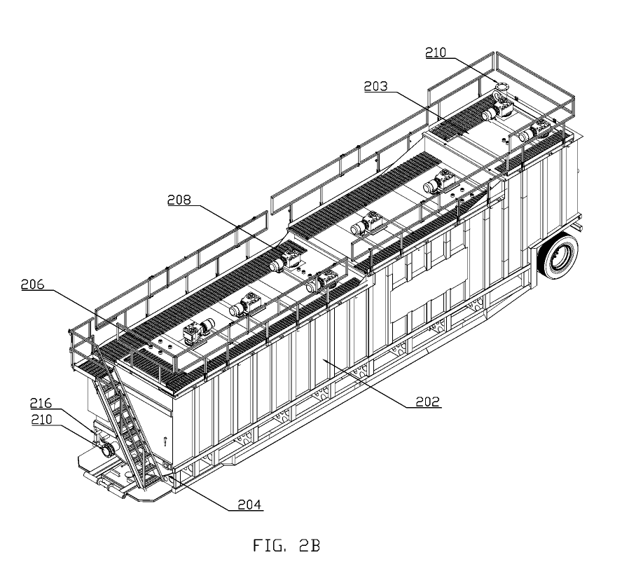

Also provided in the present disclosure is a mobile chemical treatment cell system. Referring to FIGS. 2A and 2B, example mobile chemical treatment cell systems are shown. An example mobile chemical treatment cell system includes a chemical mix tank 202, and the chemical mix tank 202 includes two or more cascading, tiered platforms 203. The cascading, tiered platforms optionally allow the raw water to flow through the chemical mix 202 by gravity, which protects the integrity of the separation of pollutants from the water because the raw water is not subjected to shear. Each tier may provide different contact times with the raw water and various treatment chemicals may optionally be added at each tier.

The chemical mix tank 202 may include a curved bottom portion 204. The mobile chemical treatment cell system further includes one or more chemical injection ports 206 and one or more mixers 208, as well as influent 210 and effluent 212 piping assemblies. The mobile chemical treatment cell system further includes a trailer 134, and the mobile chemical treatment cell system and all of its components are adapted to be positionable on the trailer 134. The chemical treatment cell system may optionally operate covered or uncovered.

The influent piping assembly 210 may be configured to accept raw water. For example, the influent piping assembly 210 is connectably attached to the chemical mix tank 202. The raw water accepted through the influent piping assembly 210 may be transported into the chemical mix tank 102.

The one or more chemical injection ports 206 may accept treatment chemicals into chemical mix tank 202. One or more mixers 208 may optionally inject or dissolve treatment chemicals into the chemical mix tank 202. For example, the treatment chemicals may include one or more chemical agents. The one or more chemical agents may optionally contact the raw water. The system may further include a mobile chemical feed trailer (not shown), which includes one or more chemical pumps. The one or more chemical pumps optionally pump treatment chemicals from the mobile chemical feed trailer to the one or mixers 208 or one or more chemical injection ports 206 of the chemical mix tank 202.

The two or more cascading, tiered platforms 203 may be adapted for the flow of the raw water within the chemical mix tank 202 by gravitational force. The effluent piping assembly 212 of the chemical mix tank 202 may discharge the chemically-treated water into a treatment system (not shown), a storage tank (not shown), and/or other appropriate facility. The treatment system may include a mobile flotation cell system, as described herein.

The entire system may be transported and positioned adjacent or proximate to a raw water source. The entire system and all components may be adapted for clearance below the uppermost part of the chemical mix tank 202 for transportation of the entire system. The trailer 132 may optionally include a standard frac tank chassis. For example, the trailer 134 may include a standard 452-inch floor assembly. The trailer 134 may include a standard 488-inch or 500-inch floor assembly, or a trailer or floor assembly of any other appropriate length. The trailer optionally includes a longitudinally sloped chasis, such that any water or liquid may flow via gravity from the distal end of the trailier to the proximal end. The degree of longitudinal slope may be about 5 degrees. The trailer may also include an ISO-20 or ISO-40 container. The trailer optionally includes a single axle trailer or a flatbed.

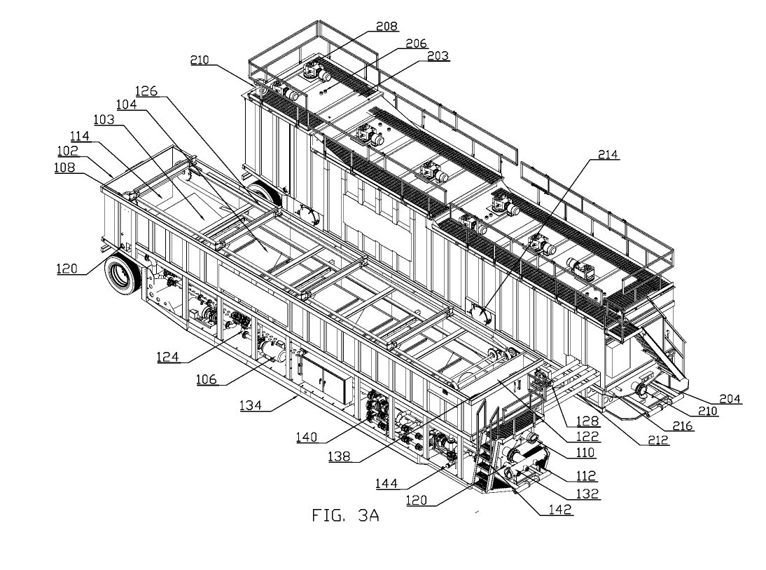

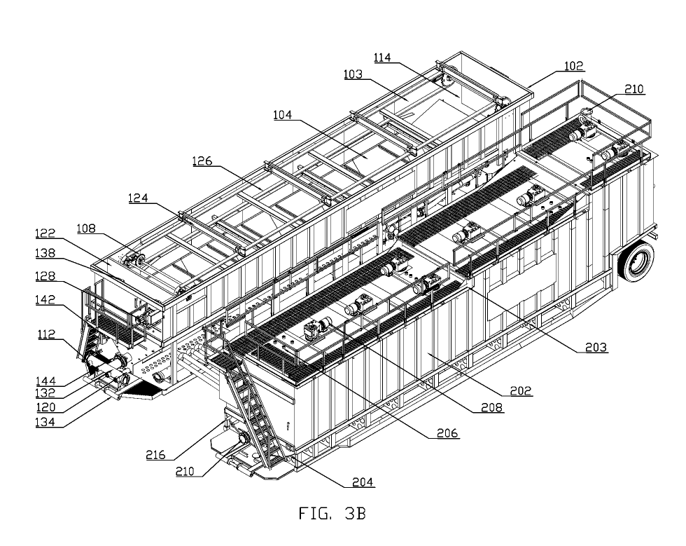

Also provided in the present disclosure is an integrated treatment system. Example integrated treatment systems are shown in FIG. 3A and 3B. The example integrated treatment system may include a chemical mix tank 202 with two or more cascading, tiered platforms 203. The chemical mix tank 202 further includes one or more mixers 208, one or more chemical injection ports 206, and influent 210 and effluent 212 piping assemblies. The chemical mix tank 202 and all of the components thereof are positionable on a trailer 134. The integrated treatment system further includes a flotation tank 102 with an angled bottom portion and a scraper assembly 108. The flotation tank 102 also provides for one or more injection pumps 106, one or more sludge pumps 140, and at least one influent chamber 114. Furthermore, the flotation tank 102 includes at least one sludge chamber 130 and influent 110 and effluent 112 piping assemblies. The flotation tank 102 and all of the components thereof are positionable on a trailer 132.

Raw water may be introduced into the chemical mix tank 202 via the chemical mix tank influent piping assembly 210. The integrated treatment system may further include a mobile chemical tank (not shown). The mobile chemical feed trailer may include one or more chemical pumps, and the chemical pumps optionally pump treatment chemicals from the mobile chemical feed trailer to the one or more chemical injection ports 206 of the chemical mix tank 202. The mobile chemical feed trailer may be positionable on a trailer 134, and the interior portion of the tank may be climate-controlled.

The raw water may then optionally be treated with treatment chemicals in the chemical mix tank 202. For example, the treatment chemicals may include one or more chemical agents, and the one or more chemical agents may contact the raw water. The two or more cascading, tiered platforms 203 may optionally be adapted for the flow of raw water within the chemical mix tank 202 by gravitational force.

The chemically-treated water may be discharged through the chemical mix tank effluent piping assembly 212 and into a treatment system, a storage tank, and/or other appropriate facility. The system may include piping and valves made of a resistant material, such as, for example, polypropylene, polyvinyl chloride, metal coated with paints, epoxy, and/or anti-corrosive coatings, or composite materials, so that contact with salty raw water and the chemicals and contaminants contained therein do not corrode the system.

The integrated treatment system may include a flotation tank as described in detail herein. The chemically-treated water may be introduced into the flotation tank 102 via the influent piping assembly 110. Optionally, the influent piping assembly 110 of the flotation tank 102 may be connectably attached to the effluent piping assembly 212 of the chemical mix tank 202. The one or more injection pumps 106 may optionally inject, dissolve, and/or entrain a gas into the chemically-treated water within the flotation tank 102. The gas may include air, methane, or a combination thereof. For example, the injecting, dissolving, and/or entraining a gas into the chemically-treated water within the flotation tank may cause the particulate matter suspended in the water to float to the surface.

The raw water and suspended particulate matter may move or be transported from the at least one influent chamber 114 to the separation tank 103. The scraper assembly 108 may also include one or more mechanical blades 124 and remove or skim the sludge from the surface of the water, as described in detail herein.

The system optionally removes sludge from the chemically-treated water to produce treated water. The treated water may be transported to a clearwell 122, and the treated water in the clearwell 122 may be returned to the flotation tank 102.

A portion of the treated water may optionally be returned to the one or more injection pumps 106 for injecting, dissolving, and/or entraining a gas into the raw water of the influent chamber 114. The treated water may optionally be transported to a clearwell 122. The effluent piping assembly 112 is optionally connectably attached to the clearwell 122, and the treated water may be transported through the flotation tank effluent piping assembly 112 to a holding tank (not shown), other storage means (not shown), and/or the field for further use. The treated water may be discharged through the effluent piping assembly 112 and used for hydraulic fracturing or other appropriate means.

The treated water may be discharged via the flotation tank effluent piping assembly 112, and the treated water may be re-used for hydraulic fracturing or other appropriate means. The example integrated treatment system may also include a reverse osmosis apparatus or evaporator. The treated water may be discharged through the flotation tank effluent piping assembly 112 to the reverse osmosis apparatus or evaporator. Optionally, the reverse osmosis apparatus or evaporator may remove dissolved solids and/or salts. The reverse osmosis apparatus or evaporator may concentrate TDS to a level of at least about 75,000 ppm, for example, 75,000 ppm, 80,000 ppm, 85,000 ppm, 90,000 ppm, 95,000 ppm, 100,000 ppm, 125,000 ppm, or at least about 125,000 ppm. A cavitational evaporator may also be employed. The cavitational evaporator may concentrate TDS to a level of at least about 200,000 ppm, for example, 200,000 ppm, 225,000 ppm, 230,000 ppm, or at least about 230,000 ppm. In another aspect, an evaporate may concentrate TDS to a level approaching the point where salts crystallize and precipitate. In yet another aspect, an evaporator may concentrate TDS to a level where at least a portion of or all of the salts present begin to crystallize. In other aspects where a reverse osmosis apparatus and/or evaporator are not present, the integrated treatment system may be a closed loop system without, for example, a reverse osmosis apparatus and/or evaporator.

In various aspects, water and/or raw water treated with the example integrated treatment system of the present disclosure may be purified to a greater degree than possible with other treatment technologies. In one aspect, the example integrated treatment system may remove up to about 99.9%, for example, 75%, 80%, 85%, 90%, 91%, 92%, 93%, 94%, 95%, 96%, 97%, 98%, 99%, 99.2%, 99.4%, 99.5%, 99.6%, 99.7%, 99.8%, 99.9% or more of TDS, dissolved metals, and/or oils and grease from raw water.

The trailers 132 for the flotation tank and the chemical mix tank may include a standard frac tank chassis, or a standard 452-inch floor assembly. The trailers 134 may include a standard 488-inch or 500-inch floor assembly, or a trailer or floor assembly of any other appropriate length. The trailer optionally includes a longitudinally sloped chasis, such that any water or liquid may flow via gravity from the distal end of the trailier to the proximal end. The degree of longitudinal slope may be about 5 degrees. The trailer may also include an ISO-20 or ISO-40 container. The trailer for both the chemical mix tank and the flotation tank may include full bars for transportation of the trailers. Both the chemical mix tank and the flotation tank may optionally include one or more manholes, which may provide access to tanks for maintenance, repair, inspection, and/or any other appropriate need for entry into the tank.

In the example integrated treatment system, any one or more of the valves, pumps, scraper assemblies, mechanical blades, injection modules, or other components of the system may be manually controlled or connected to an automated control system. In one aspect, each of the components may be connected to an automated control system, such that operator training and supervision is minimized or eliminated. In still other aspects, one or more storage tanks (not shown) may be attached to the example integrated treatment system for storage of treatment chemicals, raw water, contaminated water, purified water, removed or resulting sludge, and/or concentrated dissolved solids.

In other aspects, the example integrated treatment system or a portion thereof may utilize industry standard connectors, such as, for example, CAM-LOCK style quick connects and/or ANSI flange connections. The use of such connectors on a self-contained system can facilitate rapid deployment and operation. In one aspect, an example integrated treatment system may be operational and processing raw water within a few minutes after arrival onsite. In still other aspects, any mechanical and/or electrical components of the integrated treatment system may optionally include an explosion proof construction.

The example integrated treatment system may optionally treat at least about 50 gallons per minute of raw water, for example, 400 gallons per minute, 500 gallons per minute, 600 gallons per minute, 700 gallons per minute, 800 gallons per minute, 900 gallons per minute, 1,000 gallons per minute, 1,200 gallons per minute, or at least about 1,200 gallons per minute. The mobile flotation cell system may reduce the turbidity of the raw water to less than about 3 Nephelometric Turbidity Units (NTU).

It should be appreciated that the volume capacities of the integrated treatment system may vary, depending upon, for example, the contaminants and concentration thereof in the water to be treated and the specific integrated treatment system configuration requirements. Furthermore, the size of the integrated treatment system and its various components may be configured based on whether the integrated treatment system is adapted to one mobile platform or two or more mobile platforms.

The integrated treatment system may include the chemical treatment cell and the flotation tank cell as two separate components that both can be re-located to a site and easily connected to one another, as well as other components. The various components of the integrated treatment cell, such as the chemical treatment cell and the flotation tank cell, may be adapted so that both sit on one mobile platform or two mobile platforms by varying the size and capacity of each unit. In other aspects, the integrated treatment system may be utilized as a mobile unit or as an immobile unit. For example, the integrated treatment system may be used in the oil and gas industry. Furthermore, the integrated treatment system may be used in other industries where water treatment, whether mobile or immobile, is necessary. For example, the integrated mobile treatment system may be used in the offshore setting, such as, for example, offshore drilling. In the context of offshore drilling, the integrated treatment system may be adapted to be placed on one mobile platform. Furthermore, the volume capacities of the various components of the integrated treatment system may be adapted accordingly for the offshore setting, or other appropriate settings.

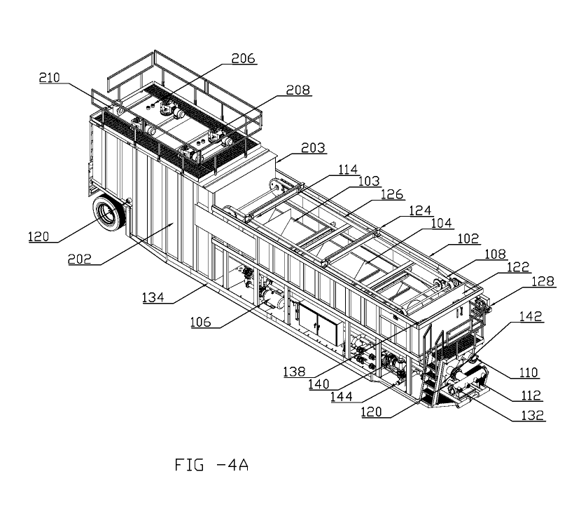

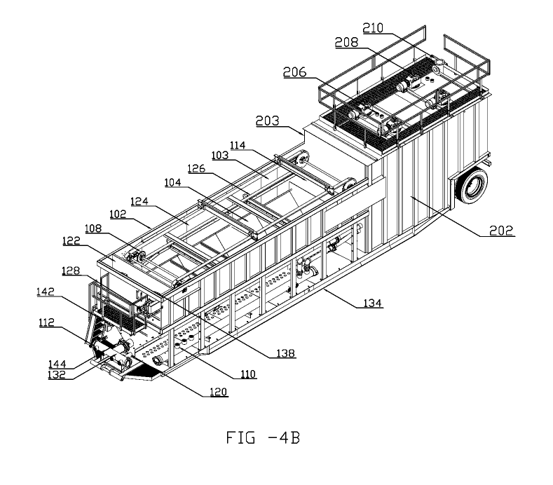

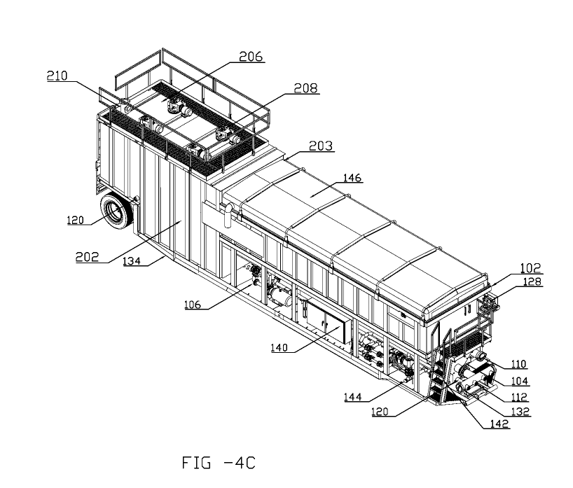

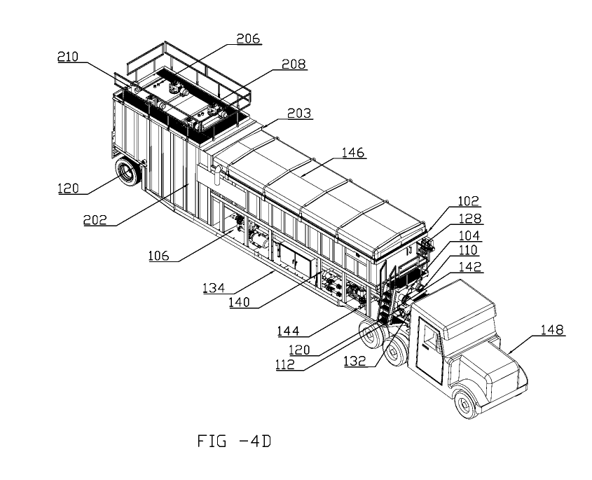

As shown in FIGS. 4A-4D, example integrated treatment systems are shown. An example integrated treatment system may be adapted such that the chemical mix tank and the flotation tank are situated on the same trailer. Optionally, an example integrated treatment system may be adapted such that a chemical feed tank, a chemical mix tank, and a flotation tank are situated on the same trailer. The example integrated treatment system where both the chemical mix tank and the flotation tank are situated on the the same trailer may optionally treat at least about 50 gallons per minute of raw water, for example, 100 gallons per minute, 200 gallons per minute, 300 gallons per minute, 400 gallons per minute, 400 gallons per minute, 600 gallons per minute, or at least about 600 gallons per minute.

Also provided in the current disclosure is a method for treating raw water. The method includes providing a chemical mix tank 202, and the chemical mix tank 202 includes one or more mixers 208 and one or more chemical injection ports 206, or a combination thereof. A flotation tank 102 is also provided, and the flotation tank includes an angle-shaped bottom portion and a scraper assembly 108. Raw water is introduced into the chemical mix tank 202, and treatment chemicals are introduced from the mobile chemical feed trailer into the chemical mix tank 202. Optionally, treatment chemicals may be introduced by a chemical feed trailer therethrough the one or more chemical injection pumps 206.

Once the raw water has been treated with the treatment chemicals, the chemically-treated water is transported from the chemical mix tank 202 to the flotation tank 102. In the flotation tank 102, a gas is injected, dissolved, and/or entrained into the chemically-treated raw water within the flotation tank 102. The sludge is removed from the chemically-treated water in the flotation tank 102 to produce treated water. The method may be used in the oil and gas industry, and may optionally be used in the offshore setting. The method may be used where mobile or immobile treatment of raw is appropriate.

Many modifications and other embodiments of the disclosure set forth herein will come to mind to one skilled in the art to which this disclosure pertains having the benefit of the teachings presented in the foregoing description. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile flotation cell system comprising:
a. a flotation tank comprising a angled bottom portion, at least one influent chamber, at least one separation tank, and at least one sludge chamber;
b. a trailer;
c. one or more injection pumps;
d. a scraper assembly;
e. influent and effluent piping assemblies;
f one or more sludge pumps; and
g. wherein the flotation tank, one or more injection pumps, one or more sludge pumps, scraper assembly, and influent and effluent piping assemblies are adapted to be positionable on the trailer.

2. The system of claim 1, wherein the influent piping assembly is configured to accept raw water.

3. The system of claim 2, further comprising at least one influent chamber connectably attached to the influent piping assembly.

4. The system of claim 3, wherein raw water accepted through the influent piping assembly is transported to the at least one influent chamber.

5. The system of claim 4, wherein the one or more injection pumps are adapted for injecting, dissolving, and/or entraining a gas into the raw water within the at least one influent chamber.

6. The system of claim 5, wherein the gas comprises air, methane, or a combination thereof.

7. The system of claim 6, wherein injecting, dissolving, and/or entraining a gas into the raw water within the at least one influent chamber or the separation tank causes particulate matter suspended in the water to float to the surface.

8. The system of claim 4, wherein the raw water can be chemically-treated raw water, wherein the raw water is treated with one or more chemicals before transportation into the at least one influent chamber.

9. The system of claim 7, wherein the raw water and suspended particulate matter move or are transported from the at least one influent tank to the separation tank.

10. The system of claim 1, wherein the angled bottom portion of the flotation tank is configured such that solid waste settles in the bottom thereof.

11. The system of claim 10, further comprising a sludge auger positioned at the base of the angled bottom portion of the flotation tank, and further comprising an auger motor to advance and/or cause rotation of the sludge auger.

12. The system of claim 11, further comprising an effluent sludge waste drain, and wherein the sludge auger moves the sludge waste to the effluent sludge waste drain and into a means for storage or further treatment.

13. The system of claim 1, wherein the scraper assembly further comprises one or more mechanical blades, and wherein the one or more mechanical blades span the width of the flotation tank, and wherein the one or more mechanical blades are attached to a chain, rope, and/or cable.

14. The system of claim 13, further comprising a scraper assembly motor, wherein the scraper assembly motor advances the chain, rope, and/or cable that the one or more mechanical blades are attached thereto along the length of the separation tank.

15. The system of claim 14, wherein the one or more mechanical blades skim or remove the floating contaminants from the surface of the raw water in the separation tank.

16. The system of claim 15, wherein the at least one sludge chamber is situated at the proximal end of the flotation tank.

17. The system of claim 16, wherein the floating contaminants removed by the one or more mechanical blades of the scraper assembly are placed in the at least one sludge chamber.

18. The system of claim 17, wherein all or a portion of the water contained within the floating contaminants is removed to form resulting sludge.

19. The system of claim 18, wherein the water removed from the floating contaminants is returned to the flotation tank.

20. The system of claim 18, further comprising a sludge discharge connection connected to the at least one sludge chamber and the one or more sludge pumps, wherein the resulting sludge is pumped through the sludge discharge connection by the one or more sludge pumps.

21. The system of claim 24, wherein the resulting sludge is dried and disposed thereof.

22. The system of claim 23, further comprising a sediment tank and a sludge discharge connection connected to the sediment tank, wherein the resulting sludge is pumped through the sludge discharge connection by the one or more sludge pumps and stored in the sediment tank.

23. The system of claim 1, wherein the system removes the resulting sludge and sludge waste from the raw water in the flotation tank to produce treated water.

24. The system of claim 27, wherein the treated water is transported to a clearwell.

25. The system of claim 28, wherein the treated water in the clearwell can be returned to the flotation tank.

26. The system of claim 23, wherein a portion of the treated water is returned to the influent chamber.

27. The system of claim 23, wherein a portion of the treated water is returned to the one or more injection pumps for injecting, dissolving, and/or entraining a gas into the raw water in the influent chamber.

28. The system of claim 23, wherein the treated water is transported therethrough the effluent piping assembly to a holding tank, other storage means, and/or the field for further use.

29. The system of claim 28, wherein the effluent piping assemblies comprises a header measuring about 8 inches.

30. The system of claim 1, further comprising one or more flow mechanisms, wherein the flow mechanisms cause the raw water to flow in a first direction through the flotation tank.

31. The system of claim 1, wherein one or more flow mechanism causes the raw water to flow in an opposing and/or orthogonal direction to the first direction of the raw water, such that turbulent conditions are maintained.

32. The system of claim 1, wherein the trailer comprises a standard frac tank chassis.

33. The system of claim 1, wherein the trailer comprises a standard 452-inch floor assembly.

34. The system of claim 1, wherein the entire system can be transported and positioned adjacent or proximal to a raw water source.

35. The system of claim 1, wherein the pumps are placed on the trailer floor adjacent to the angled bottom portion of the flotation tank.

36. The system of claim 1, wherein the system may be used in the oil and gas industry.

37. The system of claim 1, wherein the entire system and all components are adapted for clearance below the uppermost part of the flotation tank for transportation of the entire system.

38. The system of claim 1, further comprising a generator.

39. The system of claim 1, wherein the system is capable of treating at least about 50 gallons per minute of raw water.

40. The system of claim 1, wherein the system is capable of treating at least about 1,000 gallons per minute of raw water.

41. The system of claim 1, wherein turbidity of the raw water is reduced to less than about 100 Nephelometric Turbidity Units.

42. The system of claim 1, wherein turbidity of the raw water is reduced to less than about 3 Nephelometric Turbidity Units.

43. The system of claim 1, further comprising monitoring equipment, wherein the monitor equipment monitors various water conditions.

44. The system of claim 43, wherein the various water conditions comprise the pH, turbidity, and/or mineral content.

45. The system of claim 44, wherein pH control additives or other chemical additives can be added in response to various water conditions.

46. The system of claim 1, wherein the angled bottom portion further comprises a V-shaped bottom portion.

47. A mobile chemical treatment cell system comprising:
a. a chemical mix tank comprising two or more cascading, tiered platforms;
b. one or more chemical injection ports;
c. one or more mixers;
d. influent and effluent piping assemblies;
e. trailer; and
f. wherein the chemical mix tank, one or more chemical injection ports, one or more mixers, and influent and effluent piping assemblies are adapted to be positionable on the trailer.

48. The system of claim 47, wherein the influent piping assembly is configured to accept raw water.

49. The system of claim 48, wherein the influent piping assembly is connectably attached to the chemical mix tank.

50. The system of claim 49, wherein the raw water accepted through the influent piping assembly is transported into the chemical mix tank.

51. The system of claim 50, wherein the one or more chemical injection ports accept treatment chemicals into the chemical mix tank.

52. The system of claim 51, wherein the treatment chemicals comprise one or more chemical agents, and wherein the one or more chemical agents contact the raw water.

53. The system of claim 52, wherein the one or more mixers cause the treatment chemicals to contact the raw water.

54. The system of claim 47, wherein the two or more cascading, tiered platforms are adapted for flow of the raw water within the chemical mix tank by gravitational force.

55. The system of claim 52, wherein the effluent piping assembly is configured to discharge the chemically-treated water.

56. The system of claim 55, wherein the chemically-treated water is discharged through the effluent piping assembly and into a treatment system, a storage tank, and/or other appropriate facility.

57. The system of claim 56, wherein the treatment system is a mobile flotation cell system.

58. The system of claim 47, wherein the trailer comprises a standard frac tank chassis.

59. The system of claim 47, wherein the trailer comprises a standard 452-inch floor assembly.

60. The system of claim 47, wherein the entire system can be transported and positioned adjacent or proximal to a raw water source.

61. The system of claim 47, wherein the entire system and all components are adapted for clearance below the uppermost part of the flotation tank for transportation of the entire system.

62. The system of claim 47, wherein the chemical mix tank comprises a curved bottom portion.

63. An integrated mobile treatment system comprising:
a. a chemical mix tank comprising two or more cascading, tiered platforms, one or more mixers, one or more chemical injection ports influent and effluent piping assemblies, and wherein the chemical mix tank, one or more chemical injection ports, one or more mixers, and influent and effluent piping assemblies are adapted to be positionable on a trailer; and
b. a flotation tank comprising an angle-shaped bottom portion, and further comprising a scraper assembly, one or more injection pumps, one or more sludge pumps, at least one influent chamber, at least one sludge chamber, influent and effluent piping assemblies, and at least one separation chamber, and wherein the flotation tank, scraper assembly, one or more injection pumps, one or more sludge pumps, at least one influent chamber, at least one sludge chamber, influent and effluent piping assemblies, and at least one separation chamber are adapted to be positionable on a trailer;

64. The system of claim 63, wherein raw water is introduced into the chemical mix tank therethrough the chemical mix tank influent piping assembly.

65. The system of claim 64, further comprising a mobile chemical feed trailer, wherein the mobile chemical feed trailer comprises one or more chemical pumps, and wherein the one or more chemical pumps pump treatment chemicals from the mobile chemical feed trailer to the one or more chemical injection ports of the chemical mix tank.

66. The system of claim 65, wherein the mobile chemical feed trailer is adapted to a trailer, and wherein the interior portion of the tank is climate controlled.

67. The system of claim 64, wherein the raw water is treated with treatment chemicals in the chemical mix tank, and wherein the treatment chemicals comprise one or more chemical agents, and wherein the one or more mixers cause the chemical agents contact the raw water.

68. The system of claim 67, wherein the two or more cascading, tiered platforms are adapted for flow of raw water within the chemical mix tank by gravitational force.

69. The system of claim 68, wherein the chemically-treated water is discharged through the chemical mix tank effluent piping assembly and into a treatment system, a storage tank, and/or other appropriate facility.

70. The system of claim 69, wherein the treatment system comprises the flotation tank, and wherein the chemically-treated water is introduced into the at least one influent chamber of the flotation tank therethrough the flotation tank influent piping assembly.

71. The system of claim 70, wherein the one or more injection pumps inject, dissolve, and/or entrain a gas into the chemically-treated water within the influent chamber of the flotation tank.

72. The system of claim 71, wherein the gas comprises air, methane, or a combination thereof.

73. The system of claim 72, wherein the injecting, dissolving, and/or entraining a gas into the chemically-treated water within the at least one influent chamber of the flotation tank causes particulate matter suspended in the chemically-treated water to float to the surface.

74. The system of claim 73, wherein the chemically-treated water and suspended particulate matter move or are transported from the at least one influent tank to the separation tank.

75. The system of claim 63, wherein the scraper assembly further comprises one or more mechanical blades, and wherein the one or more mechanical blades span the width of the flotation tank, and wherein the one or more mechanical blades are attached to a chain, rope, and/or cable.

76. The system of claim 75, further comprising a scraper assembly motor, wherein the scraper assembly motor advances the chain, rope, and/or cable that the one or more mechanical blades are attached thereto along the length of the separation tank.

77. The system of claim 76, wherein the one or more mechanical blades skim or remove the floating contaminants from the surface of the chemically-treated water in the separation tank.

78. The system of claim 77, wherein the at least one sludge chamber is situated at the proximal end of the flotation tank.

79. The system of claim 78, wherein the floating contaminants removed by the one or more mechanical blades of the scraper assembly are placed in the at least one sludge chamber.

80. The system of claim 79, wherein all or a portion of the water contained within the floating contaminants is removed to form resulting sludge.

81. The system of claim 80, wherein the water removed from the floating contaminants is returned to the flotation tank.

82. The system of claim 81, further comprising a sludge discharge connection connected to the at least one sludge chamber and the one or more sludge pumps, wherein the resulting sludge is pumped through the sludge discharge connection by the one or more sludge pumps.

83. The system of claim 82, wherein the resulting sludge is dried and disposed thereof.

84. The system of claim 82, further comprising a sediment tank and a sludge discharge connection connected to the sediment tank, wherein the resulting sludge is pumped through the sludge discharge connection by the one or more sludge pumps and stored in the sediment tank.

85. The system of claim 79, wherein the system removes sludge from the chemically-treated water to produce treated water.

86. The system of claim 85, wherein the treated water is transported to a clearwell.

87. The system of claim 86, wherein the treated water in the clearwell can be returned to the flotation tank.

88. The system of claim 85, wherein a portion of the treated water is returned to the one or more injection pumps for injecting, dissolving, and/or entraining a gas into the raw water in the influent chamber.

89. The system of claim 85, wherein the treated water is transported to the one or more effluent chambers.

90. The system of claim 89, wherein the effluent piping assembly is connectably attached to one or more effluent chambers, and wherein the treated water is transported therethrough the flotation tank effluent piping assembly to a holding tank, other storage means, and/or the field for further use.

91. The system of claim 89, wherein the treated water is discharged therethrough the flotation tank effluent piping assembly, and wherein the water is used for hydraulic fracturing or other appropriate means.

92. The system of claim 63, wherein the trailers for the flotation tank and the chemical mix tank comprise a standard frac tank chassis.

93. The system of claim 63, wherein the trailers for the flotation tank and the chemical mix tank comprise a standard 452-inch floor assembly.

94. A method for treating raw water comprising:
a. providing a mobile chemical feed trailer;
b. providing a chemical mix tank, the chemical mix tank including one or more mixers and one or more chemical injection ports, or a combination thereof;
c. providing a flotation tank, the flotation tank including an angle-shaped bottom portion and a scraper assembly;
d. introducing raw water into the chemical mix tank;
e. introducing treatment chemicals from the mobile chemical feed trailer into the chemical mix tank;
f. transporting the chemically-treated water from the chemical mix tank and introducing the chemically-treated water into the flotation tank, wherein a gas is injected, dissolved, and/or entrained into the chemically-treated raw water within the flotation tank; and
g. removing the sludge from the chemically-treated water in the flotation tank and producing treated water.

95. The method of claim 94, wherein the method can be used in the oil and gas industry.

96. The method of claim 94, wherein the method can be used in the offshore setting.

97. The method of claim 94, wherein the method can be used where mobile or immobile treatment of water is appropriate.
